(19) United States
(12) Patent Application Publication
(10) Pub. No.: US 2017/0053356 A1
(43) Pub. Date: Feb. 23, 2017

(54) System and method for providing information related to a financial portfolio

(71) Applicants: Anastasia Yuelys, Woodcliff Lake, NJ (US); Lawrence W. Manning, New York, NY (US); Philip Moseley, Dorset (GB)

(72) Inventors: Anastasia Yuelys, Woodcliff Lake, NJ (US); Lawrence W. Manning, New York, NY (US); Philip Moseley, Dorset (GB)

(73) Assignee: JP Morgan Chase Bank, New York, NY (US)

(21) Appl. No.: 11/198,610

(22) Filed: Aug. 5, 2005

(51) Int. Cl. G06Q 40/00; G06Q 40/06; G06F 17/30

(52) U.S. Cl. CPC G06Q 40/10; G06F 17/30867; G06Q 40/06

(57) ABSTRACT

A method for providing information related to a financial portfolio of a client. The method can include the steps of receiving tax news data related to a specific country, determining from client-portfolio data if the portfolio is invested in the specific country, and determining an effect that the country-news data will have on the client-portfolio data. The method can include the step of displaying results-information related to the effect that the country-news data will have on the client-portfolio data. Region-news data can be used to compare the tax law or treaty network in various countries.

### FIELD OF THE INVENTION

The present invention relates generally to the providing of financial information, and, more particularly, to methods and systems for providing information related to financial portfolios.

### BACKGROUND OF THE INVENTION

In today's investing environment, many large institutional investors such as, for example, pension funds, have large portions of their portfolios invested in various different regions and countries. By placing portions of their investments in various different countries, investors hope to gain advantages and benefits. One of these benefits is the general advantage of a geographically diverse portfolio whereby an economic downturn in any one country will not dominate and have a large detrimental effect on the entire portfolio. Similarly, with such a geographically diverse portfolio, any detrimental change in the law in a single country, such as a change in the tax laws or the implementation of a treaty that detrimentally affects the investor's portfolio, only a portion of the investor's portfolio will be affected by such a change. In addition, the tax and investing laws of many countries provide for certain financial benefits when portions of a portfolio are invested outside of those countries. Thus, an investor whose portfolio is globally diverse and invested in several countries can, in certain circumstances, gain many financial benefits.

Some difficulties do exist, however, with such an investment portfolio. For example, the constant and rapid changes in the tax and securities laws in individual countries, as well as the implementation and modification of treaties between countries, make for a rapid and at times overwhelming flow of important information and news that may have a large effect on the investor's portfolio in a variety of countries. In addition, current political, business, and other events can also greatly affect the investor's portfolio in various different countries. With this large influx of news, events, and rapidly changing tax and financial laws, it is difficult for the investor to keep abreast of all this information, discern which information affects or might affect the investor's portfolio, and what modifications, if any, to the investor's investment strategy should be undertaken.

### SUMMARY OF THE INVENTION

Embodiments of the present invention satisfy these and other needs by providing to an investor financial information pertinent to the management of the investor's financial portfolio. The financial information provided to the investor can include information related to financial and investing products, and financial and investing tools for assisting in portfolio maintenance. Provided financial information can also include a listing of, and links to, external Web sites, to provide for informed financial decisions. Tax news information regarding changes to financial and tax laws in different countries can also provided, as well as client data related to the specific financial holdings and allocations within an investor's portfolio.

In addition, in embodiments of the present invention, information can be provided related to the effects that changes to financial and tax laws in rules provided in the news information will have on the financial holdings and allocations of the investor's portfolio and the client data.

Also, in embodiments of the present invention, information can be provided related to the hypothetical effects that changes to financial and tax laws and rules provided in the tax news information would have on the financial holdings and allocations of the investor's portfolio in the client data. Such information could be used by an investor to formulate hypothetical reallocations of a portfolio and determine the financial and tax consequences of such hypothetical reallocations in view of changes, or potential changes, to financial and tax laws and rules.

Thus, embodiments of the present invention provide information about an investor's portfolio, and the portfolio's allocations among different countries, as well as financial and tax information, including changes to financial and tax laws and rules in different countries. Embodiments of the invention also provide information related to the effects that changes or proposed changes to tax laws and rules could have on the investor's portfolio in different countries, and how the changes could affect the investor's portfolio if it were hypothetically to be allocated in a different manner.

### BRIEF DESCRIPTION OF THE DRAWINGS

The present invention will be more readily understood from the detailed description of exemplary embodiments presented below considered in conjunction with the attached drawings, of which:

FIG. 1 is an exemplary schematic diagram of an embodiment of the present invention;

FIG. 2 is an exemplary schematic diagram of different types of information provided by an embodiment of the present invention;

FIG. 3 is an exemplary schematic diagram illustrating information flow between logical information portions in accordance with an embodiment of the present invention;

FIG. 4 is a screen shot illustrating a main screen of a graphical user interface (GUI), in accordance with an embodiment of the present invention;

FIGS. 5a and 5b are screen shots illustrating the display of news flashes, in accordance with an embodiment of the present invention;

FIGS. 6a and 6b are screen shots illustrating the display of monthly tax monitors, in accordance with an embodiment of the present invention;

FIGS. 7a-7c are screen shots illustrating the display of market reports, in accordance with an embodiment of the present invention;

FIGS. 8a-8c are screen shots illustrating the display of a forms library, in accordance with an embodiment of the present invention;

FIGS. 9a and 9b are screen shots illustrating the display of tax profiles, in accordance with an embodiment of the present invention;

FIG. 10 is a screen shot illustrating the display of transaction taxes, in accordance with an embodiment of the present invention;

FIGS. 11a-11c are screen shots illustrating the display of account-opening information, in accordance with an embodiment of the present invention;

FIGS. 12a and 12b are screen shots illustrating the listing and display of external sites, in accordance with an embodiment of the present invention;

FIGS. 13a-13h are screen shots illustrating the display of client data information, in accordance with an embodiment of the present invention;

FIG. 14 is an exemplary flow diagram illustrating a method of providing financial information in accordance with an embodiment of the present invention; and

FIG. 15 is an exemplary flow diagram illustrating another method of providing financial information in accordance with an embodiment of the present invention.

It is to be understood that the attached drawings are for purposes of illustrating the concepts of the invention and may not be to scale.

### DETAILED DESCRIPTION OF THE INVENTION

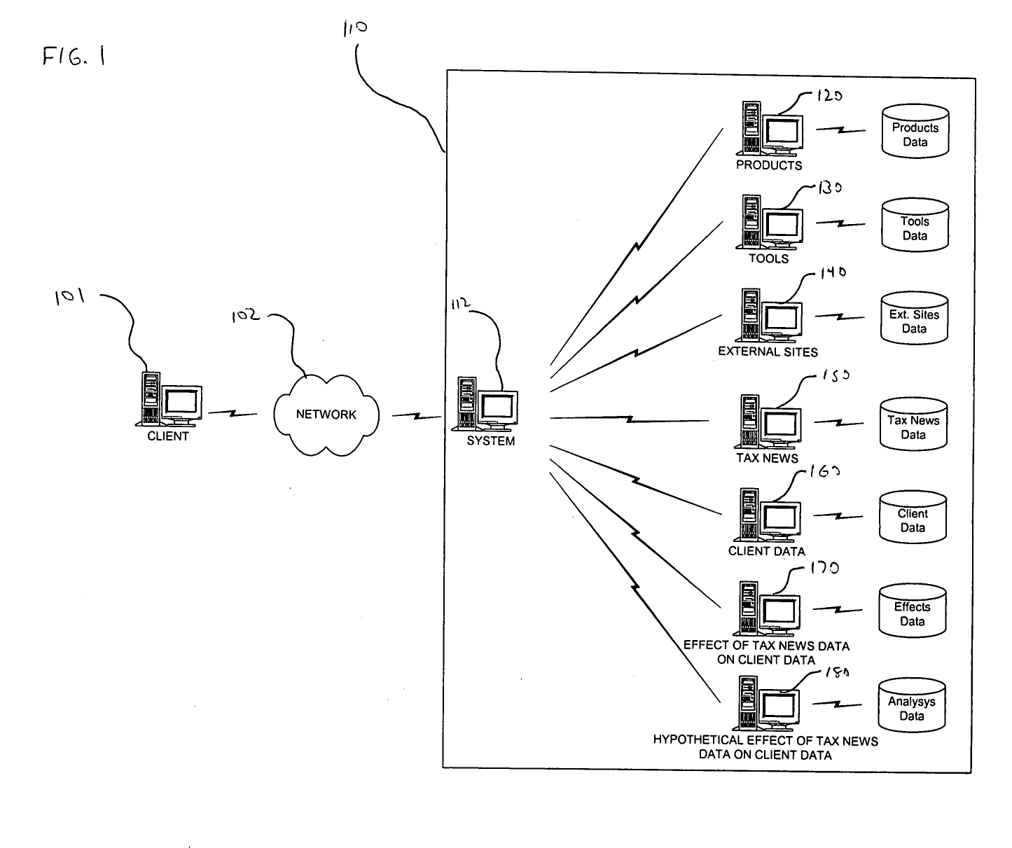

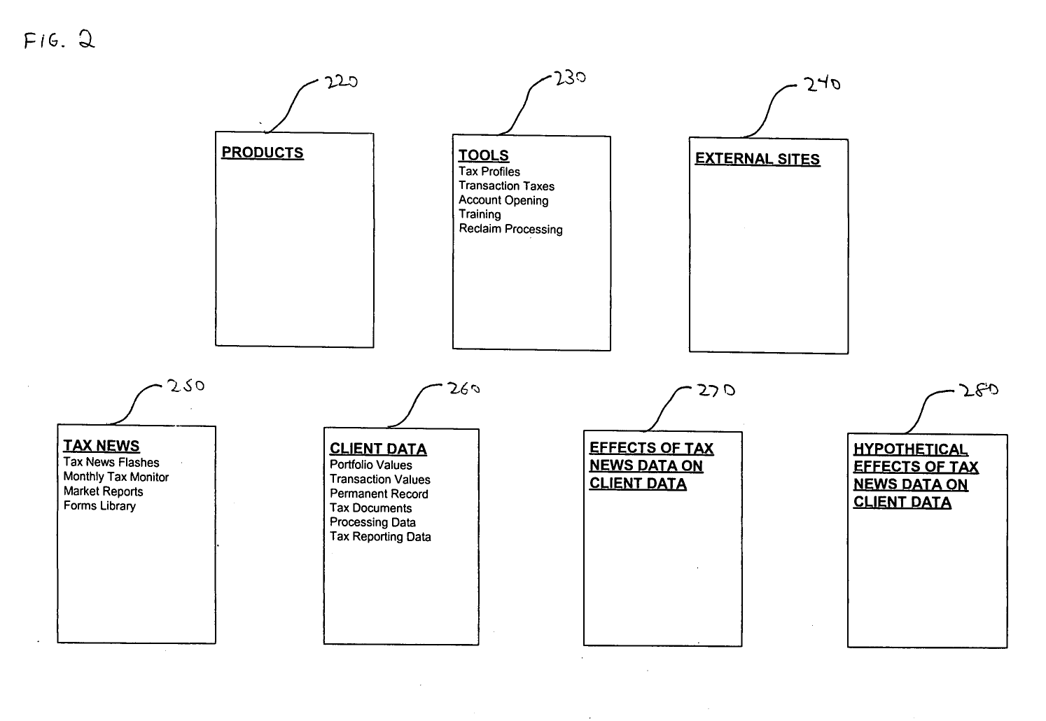

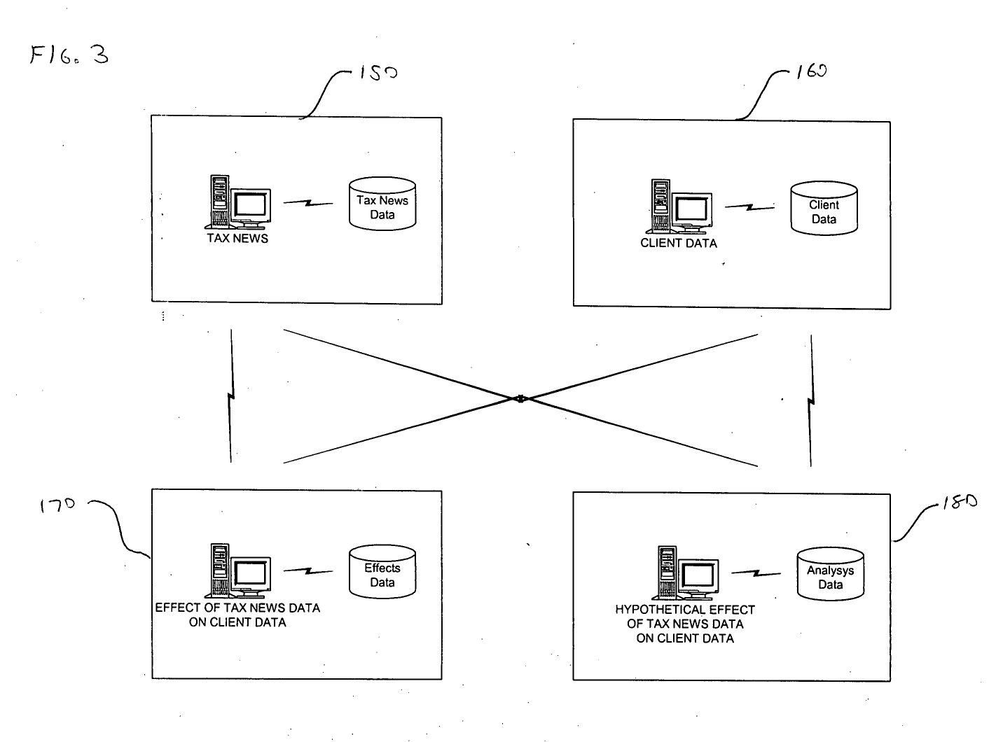

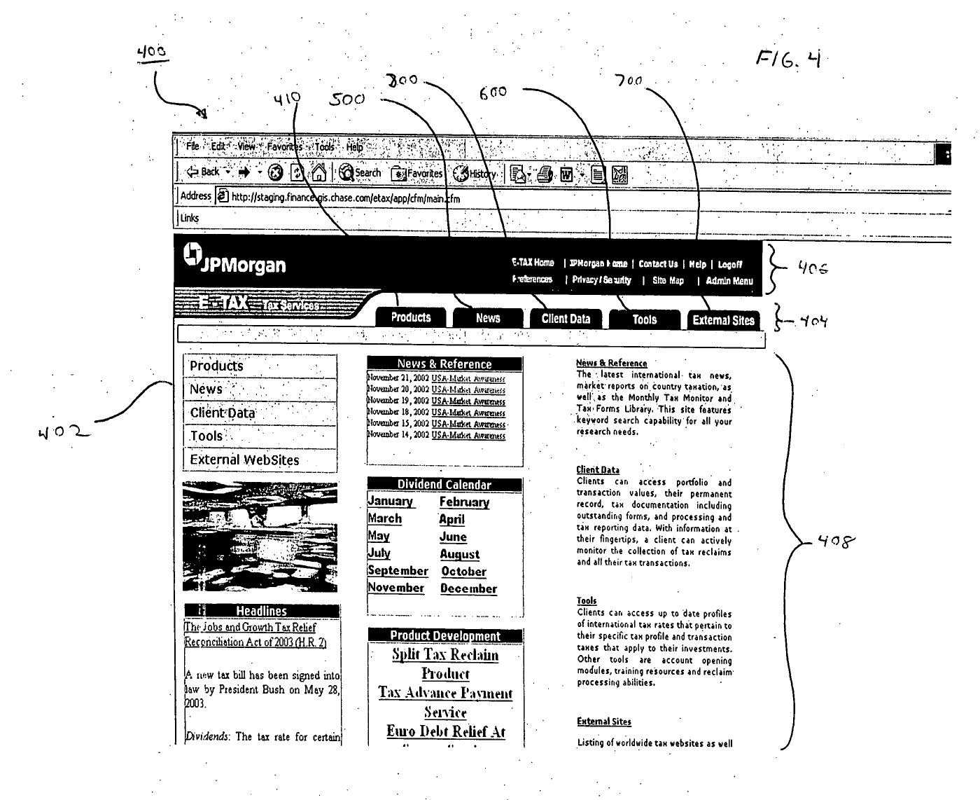

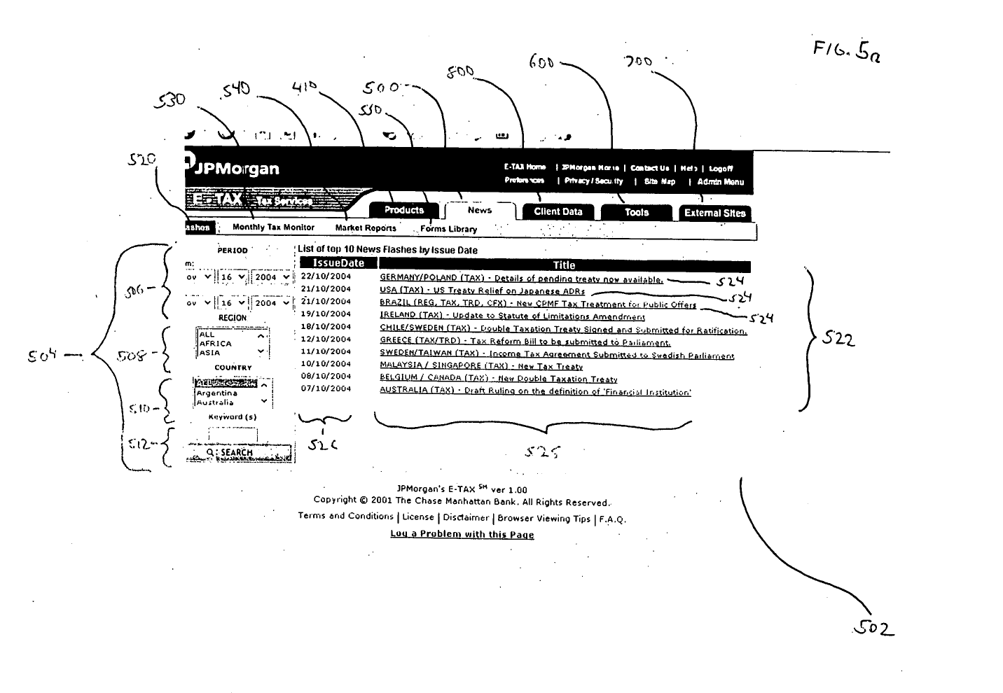

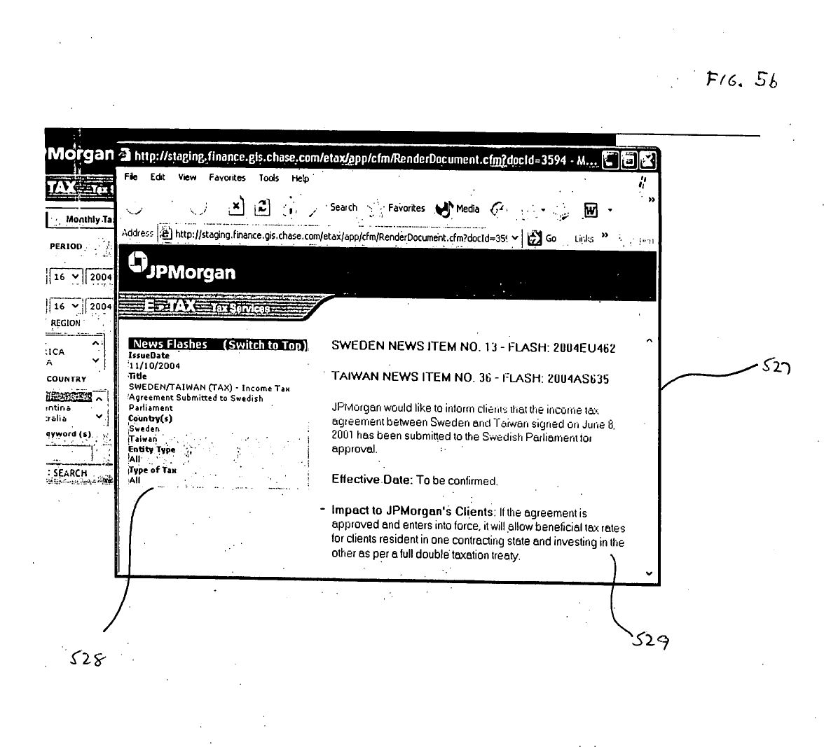

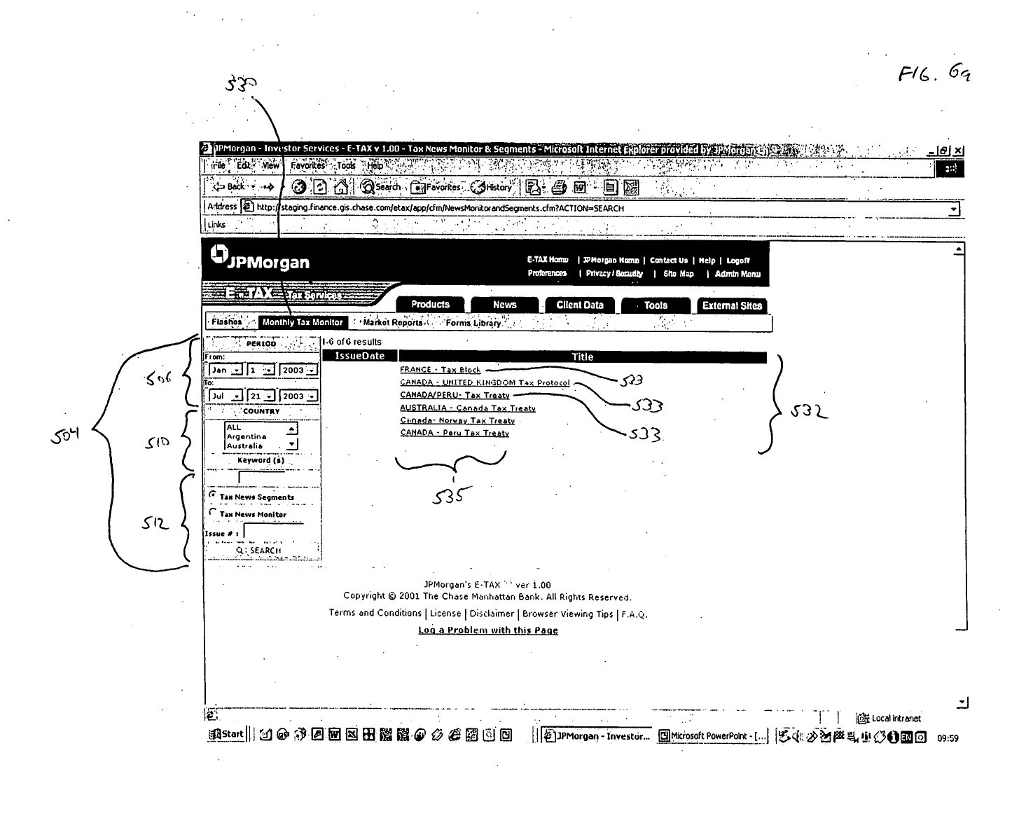

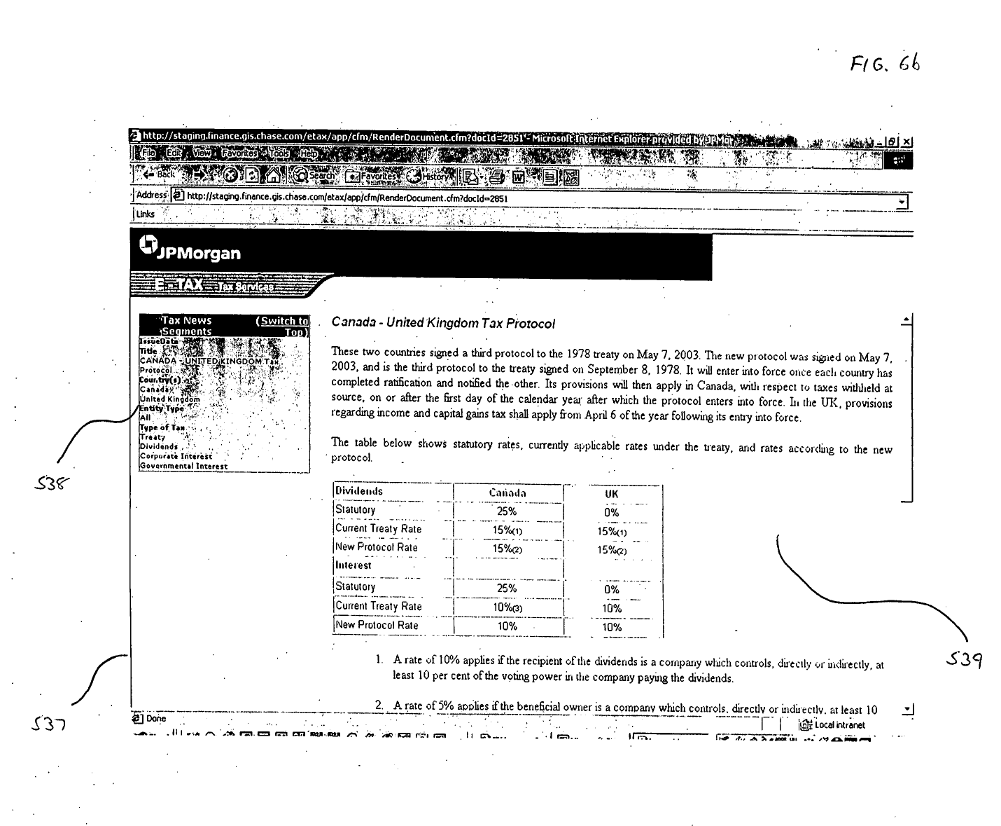

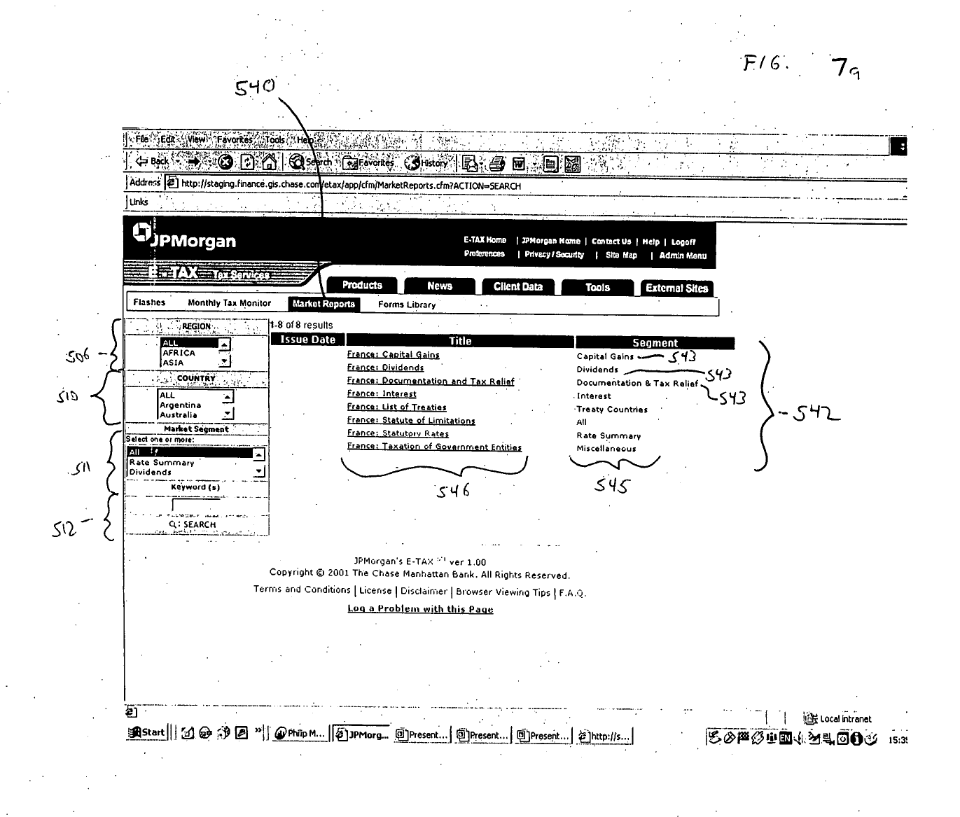

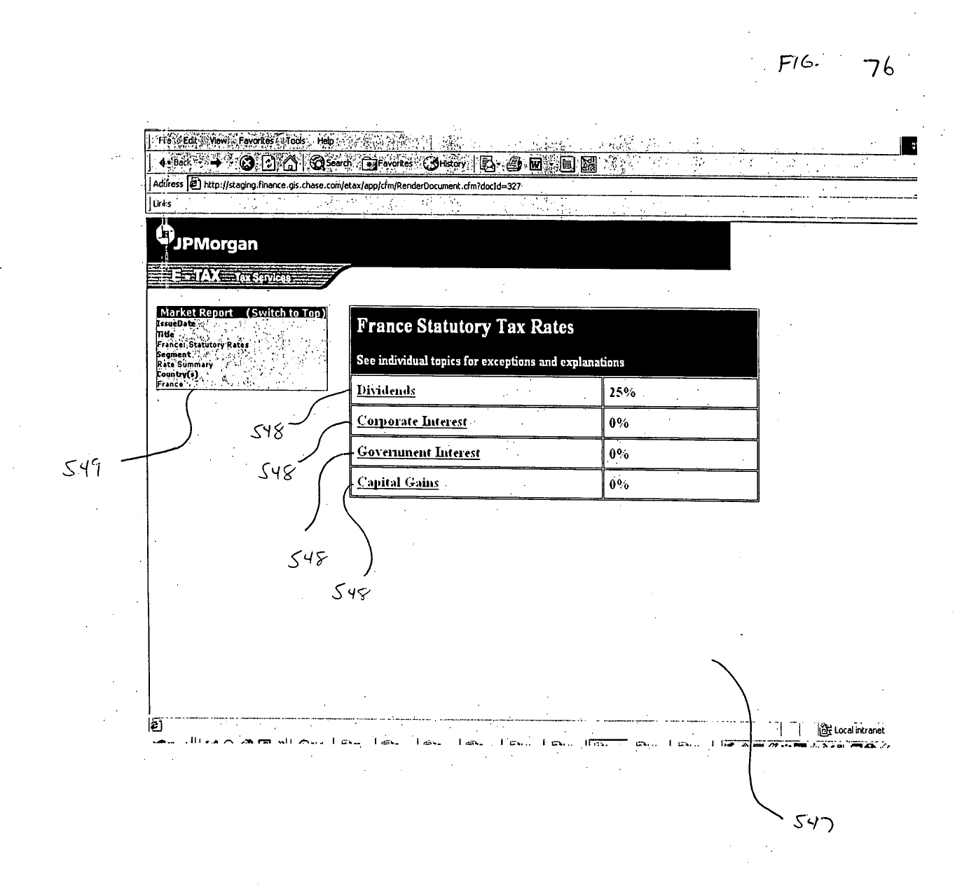

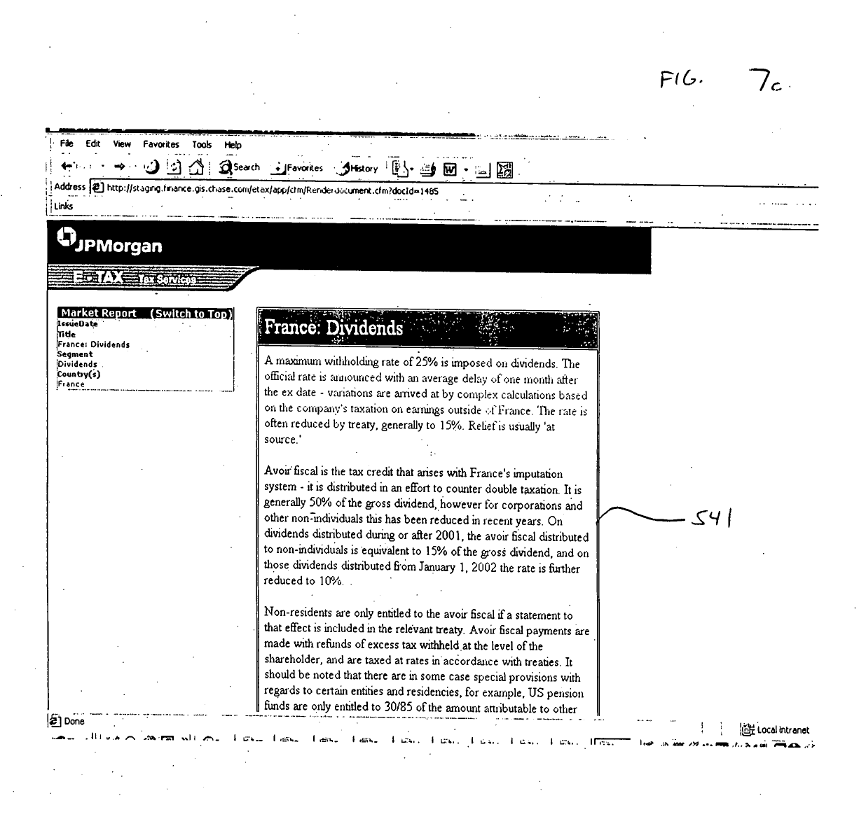

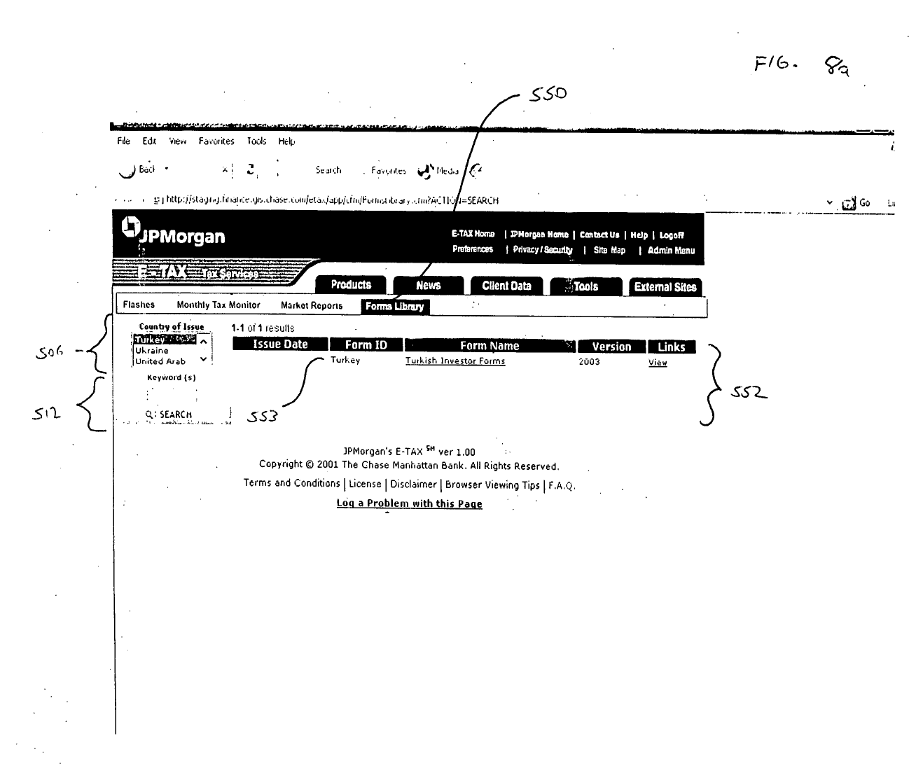

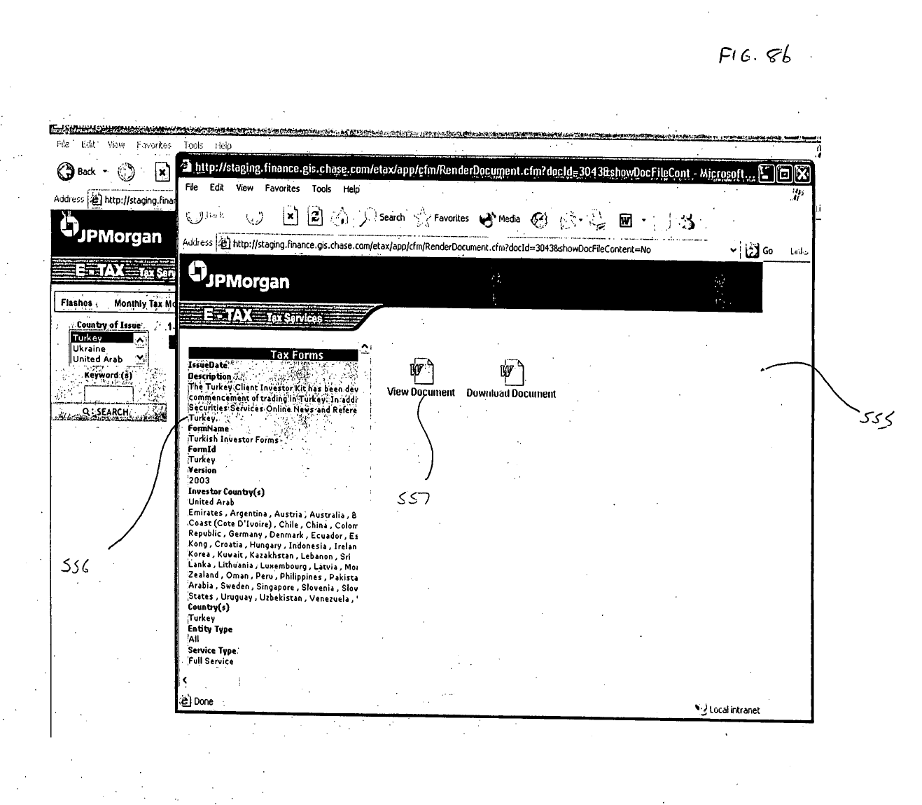

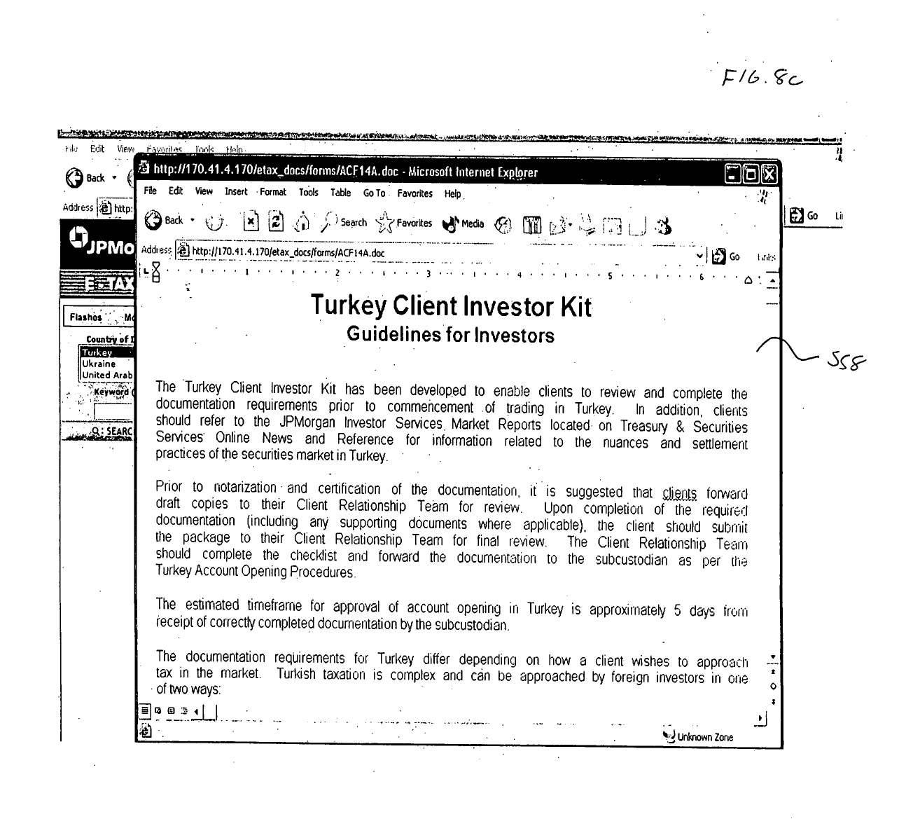

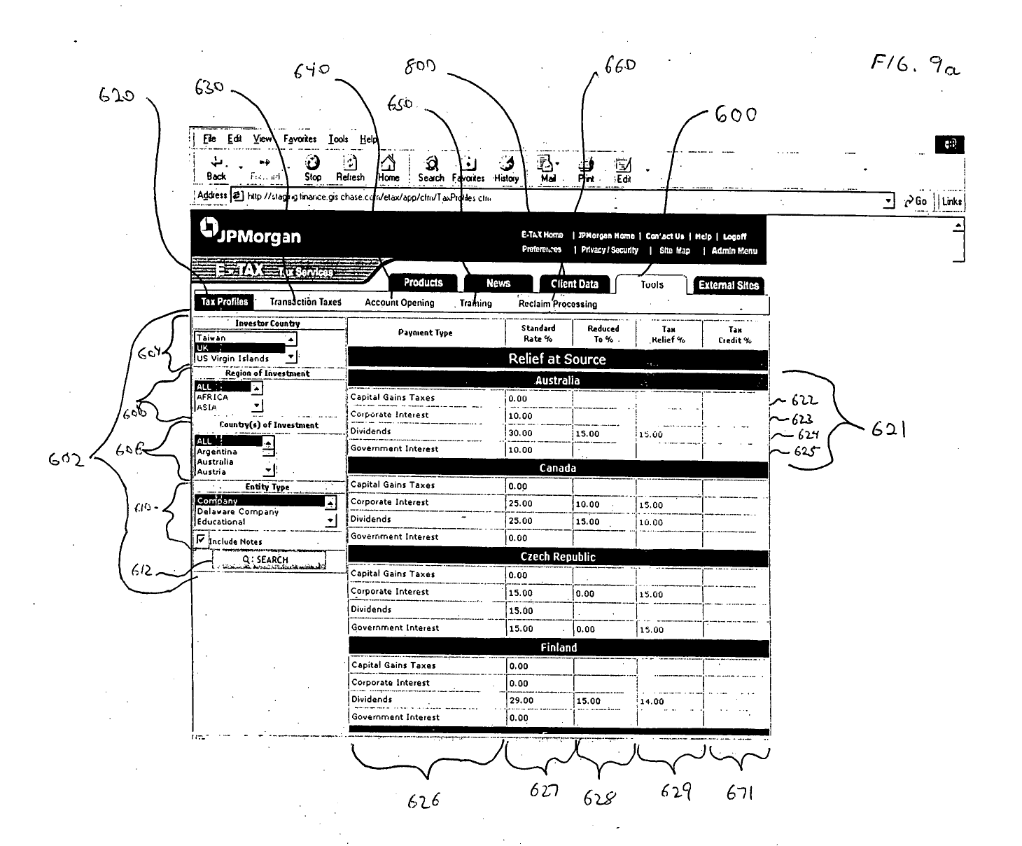

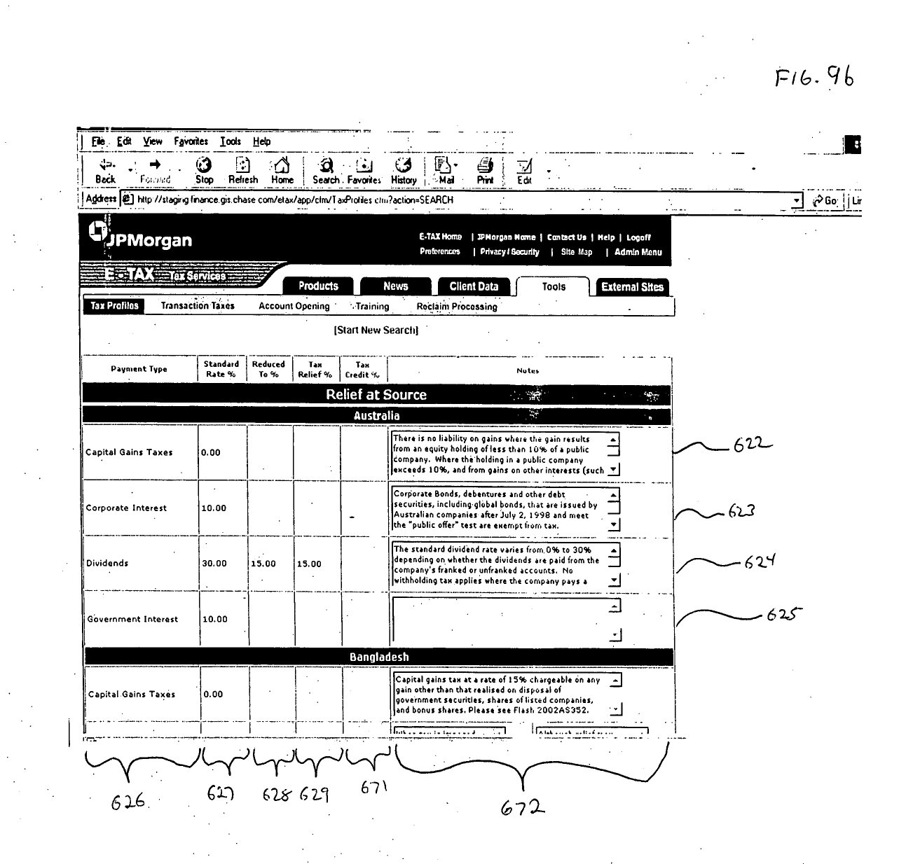

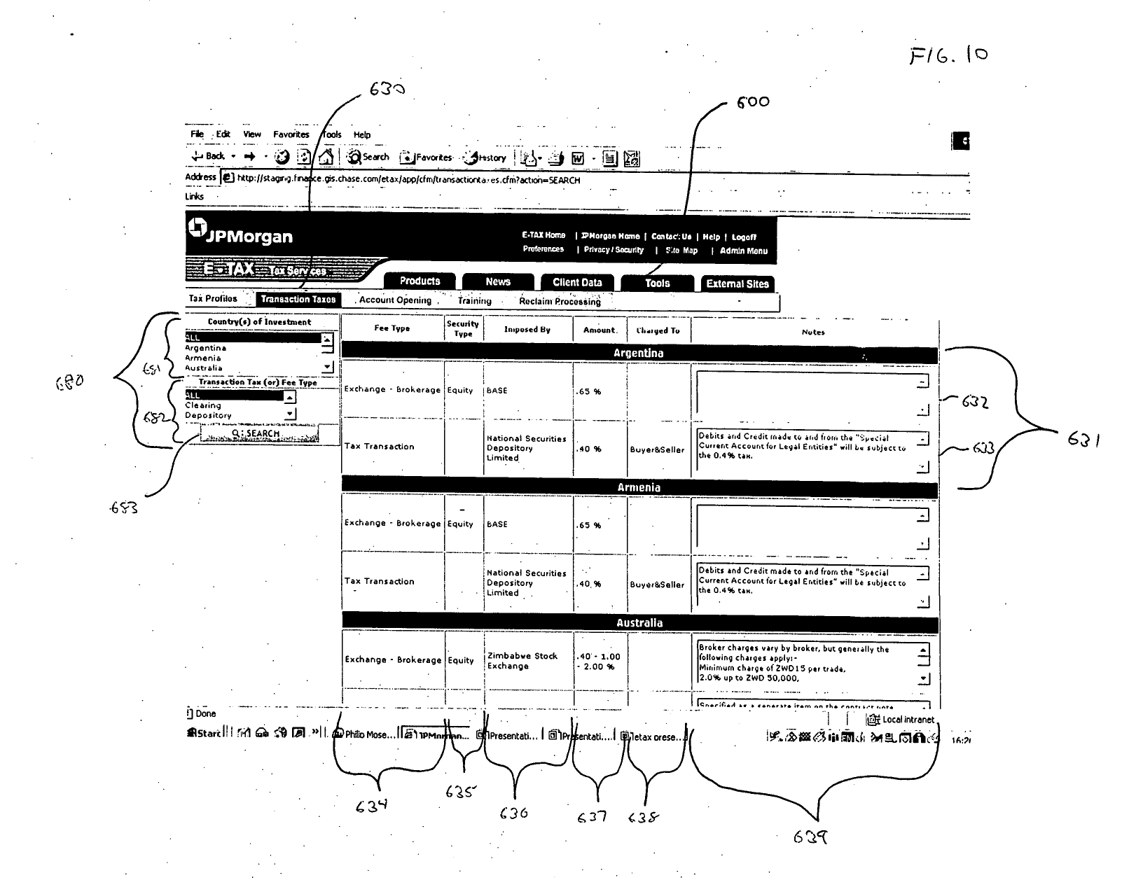

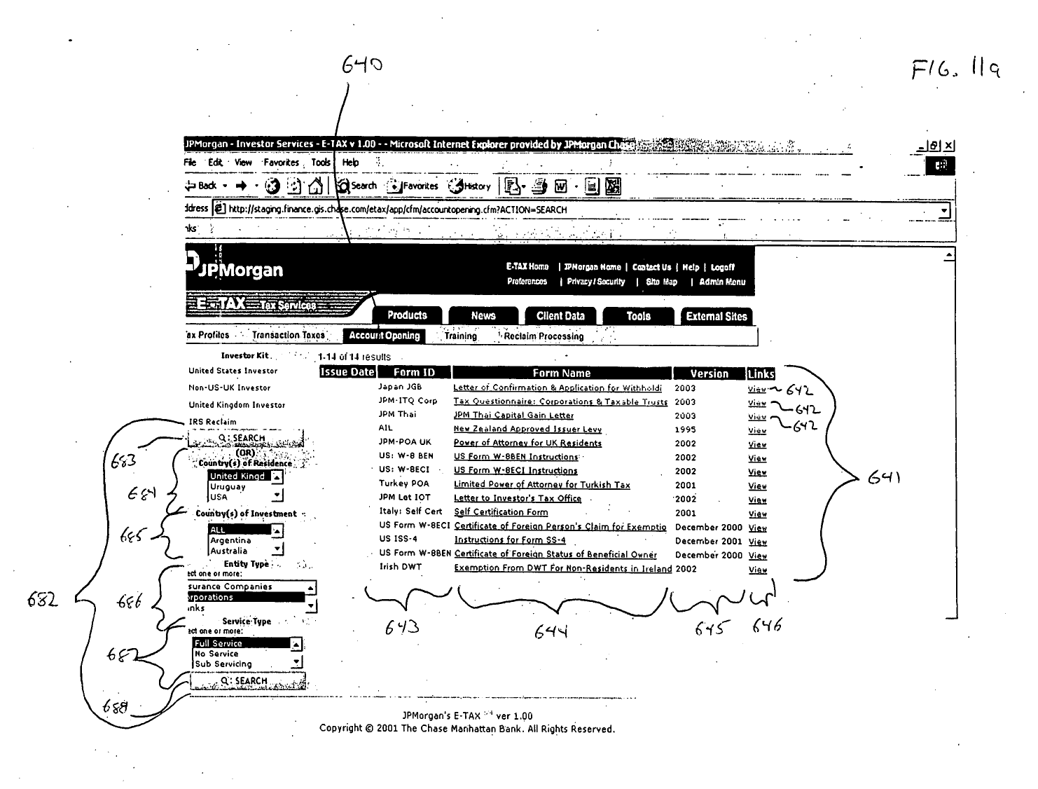

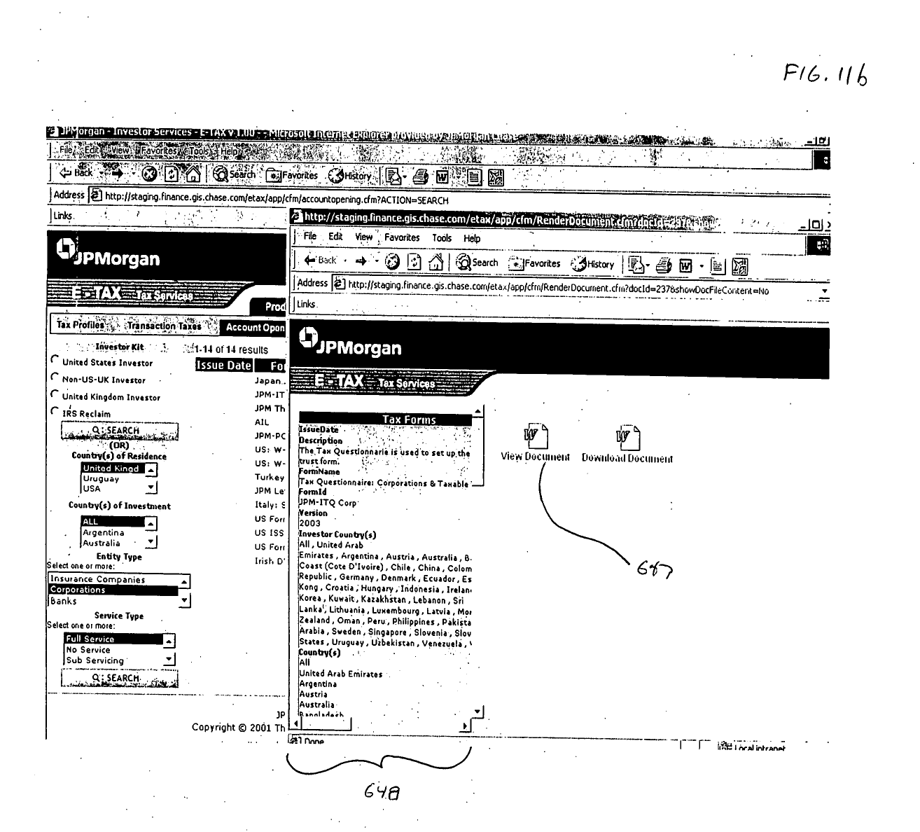

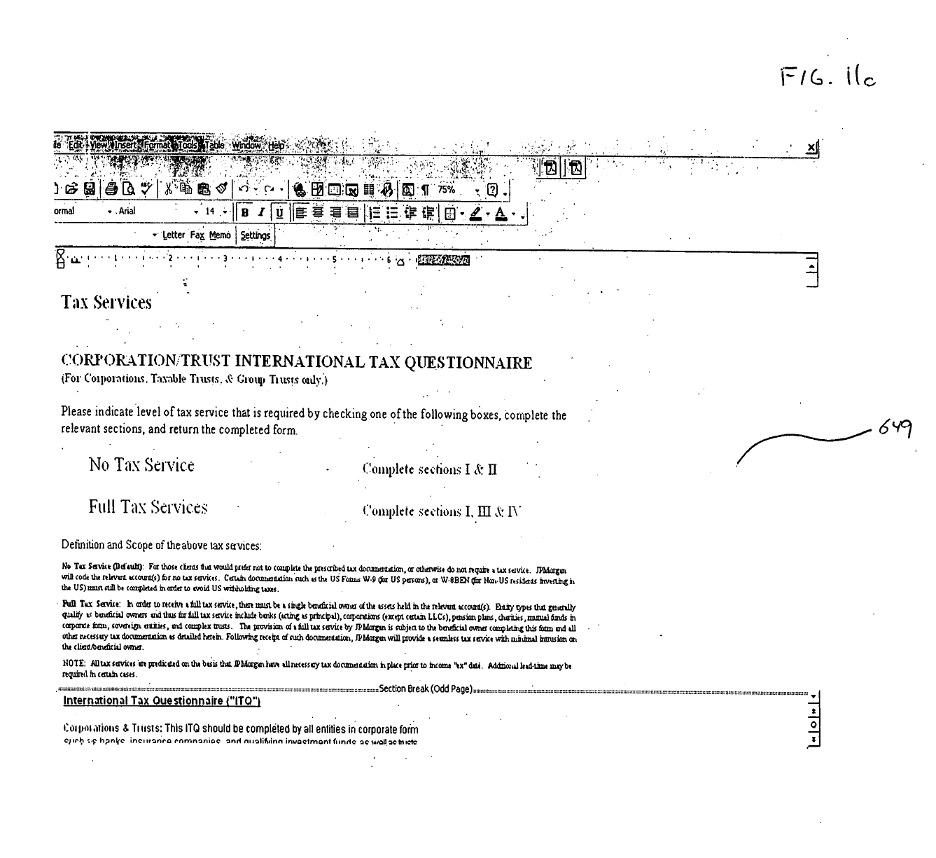

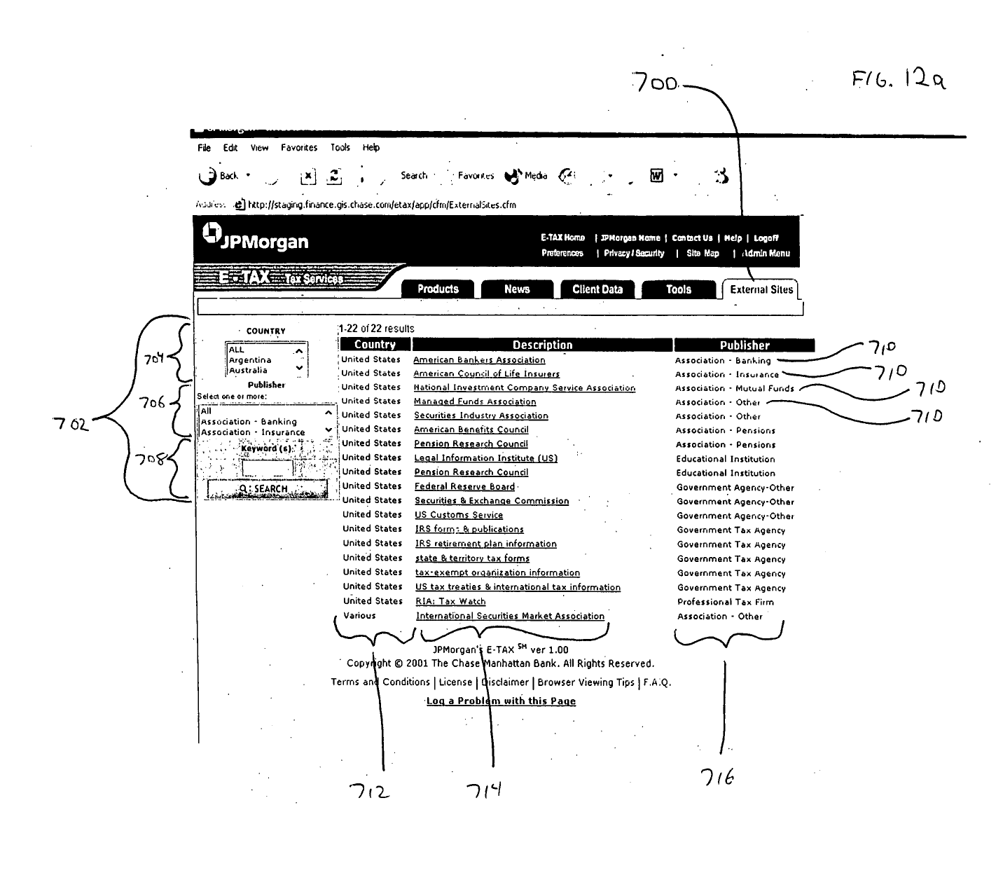

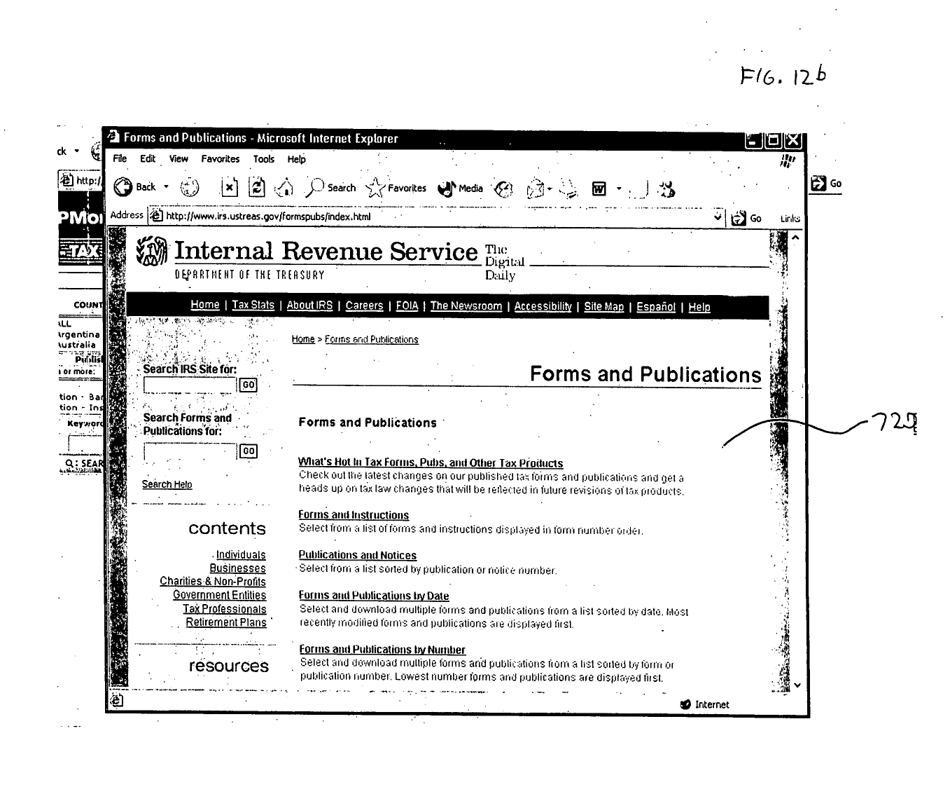

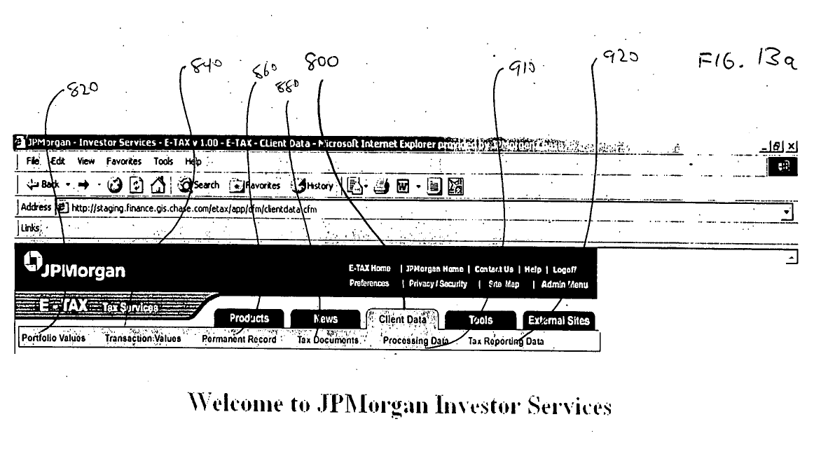

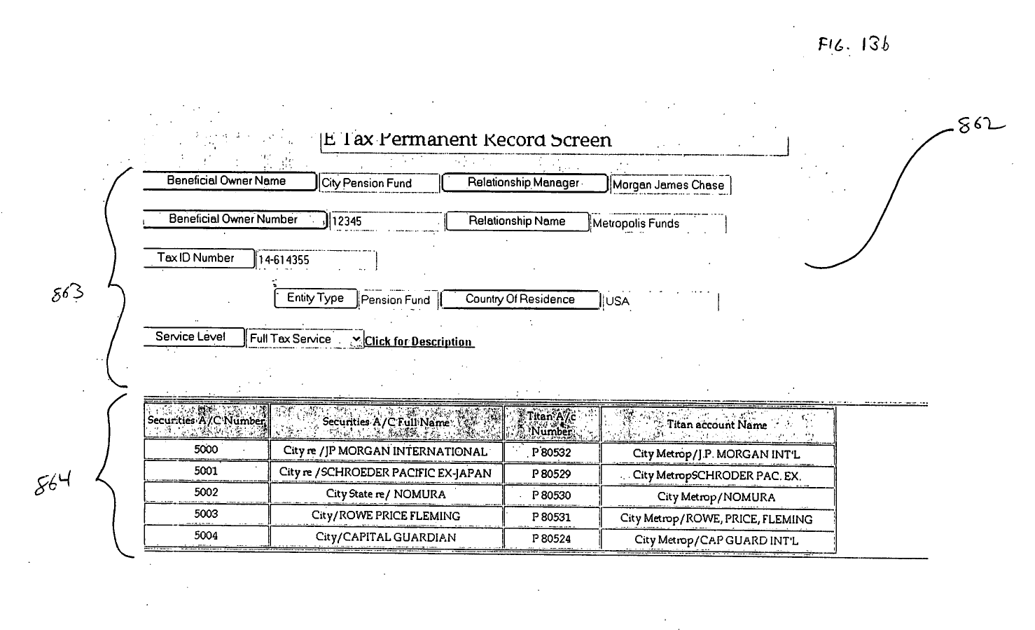

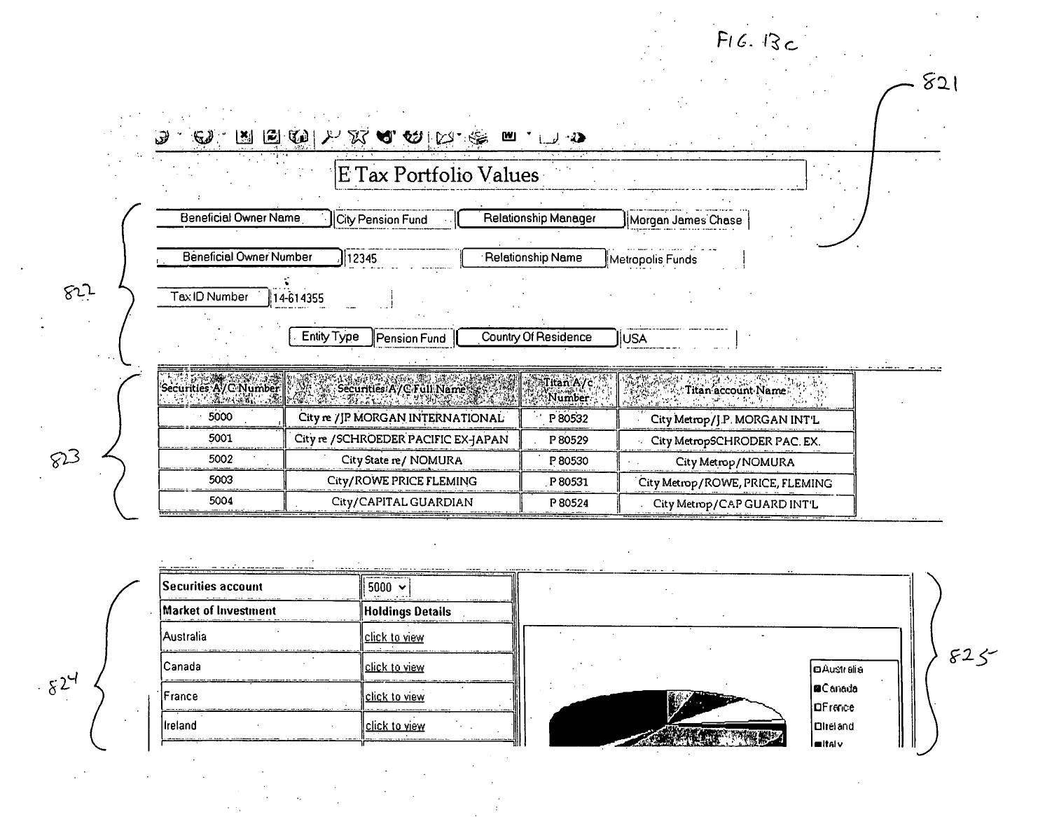

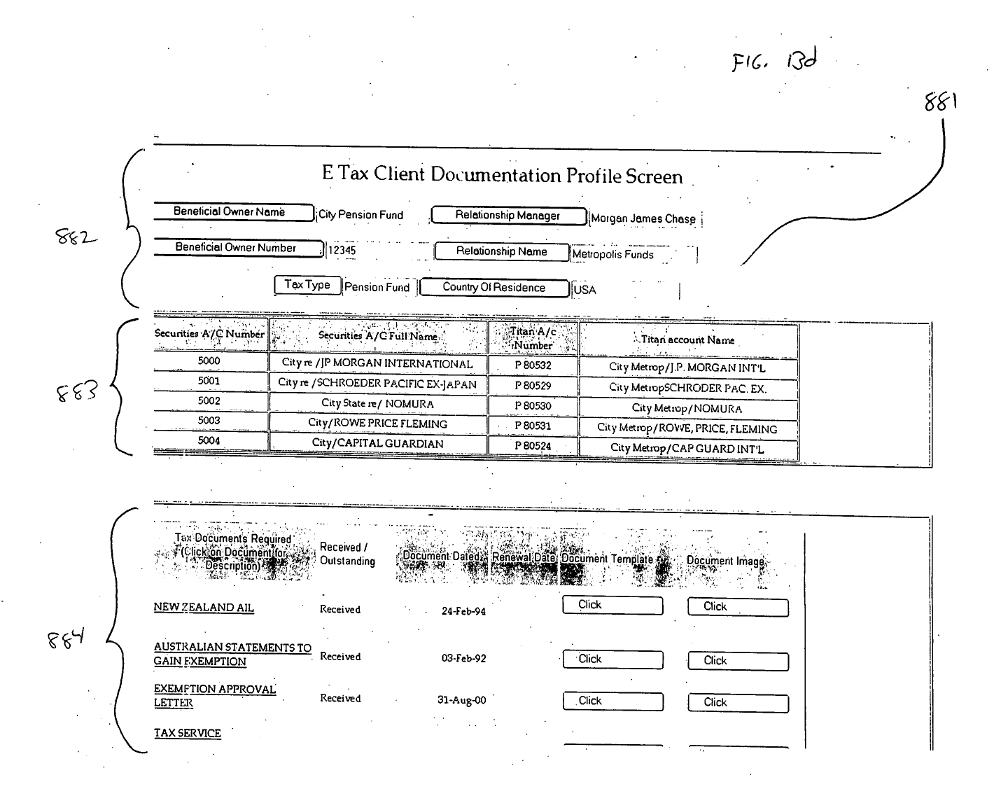

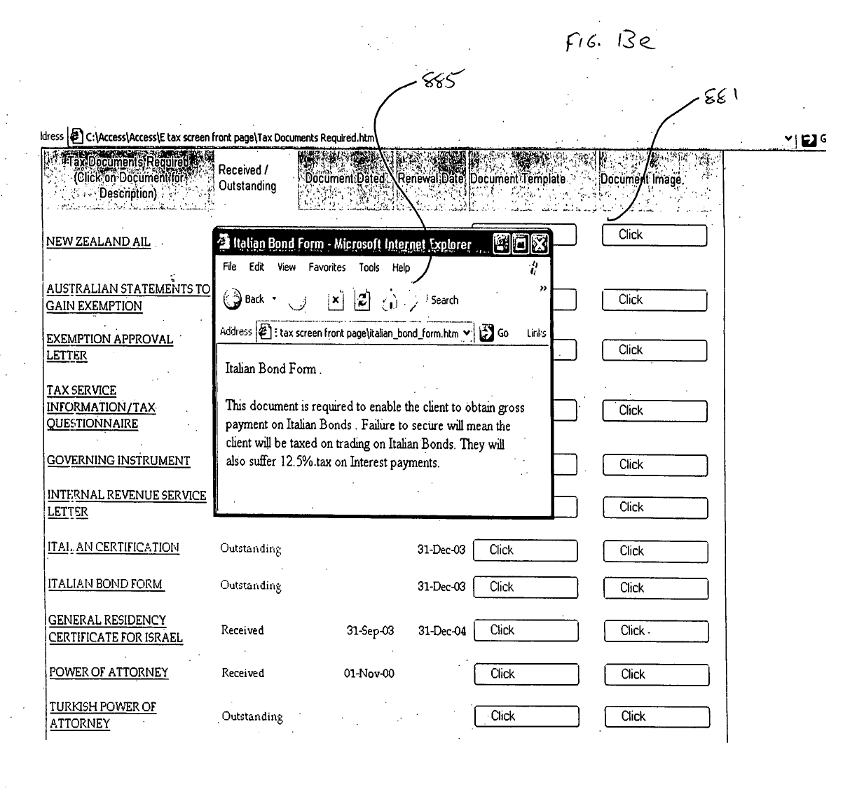

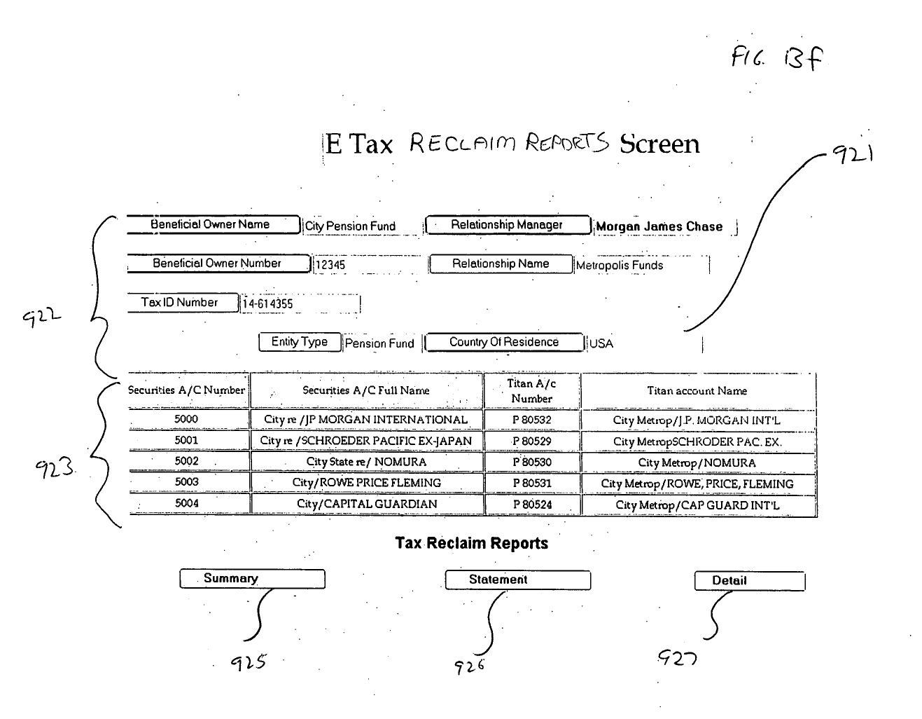

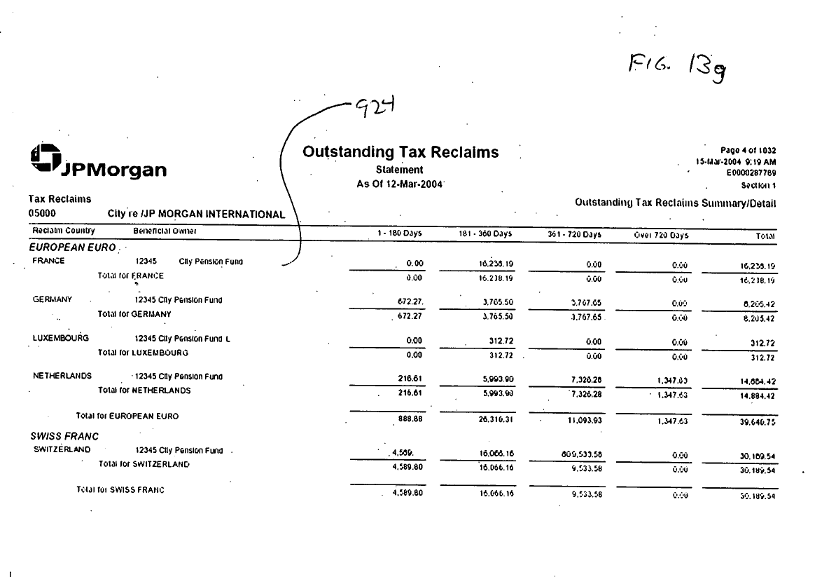

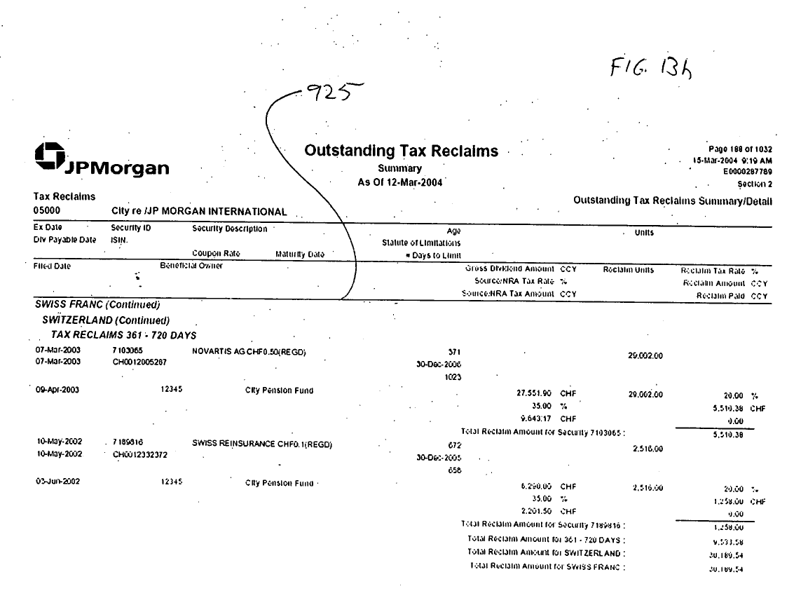

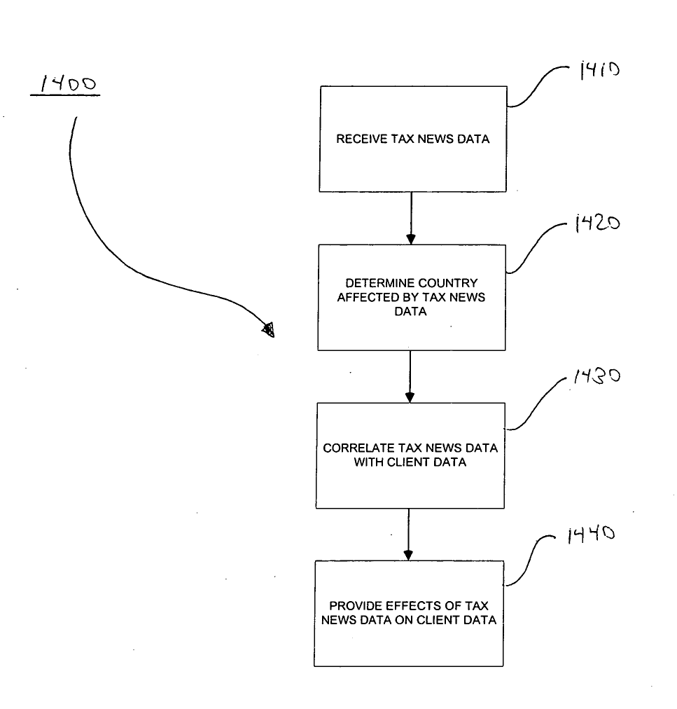

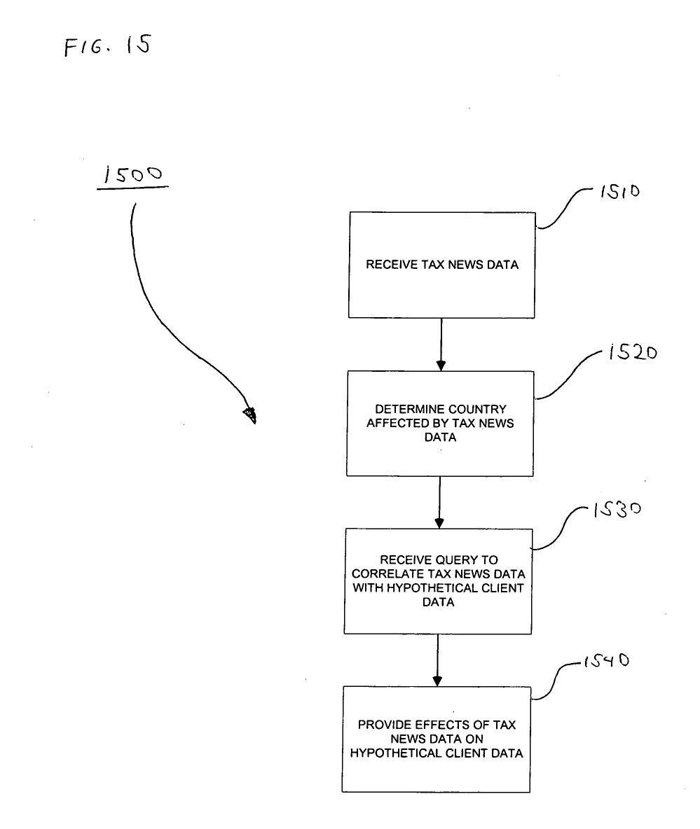

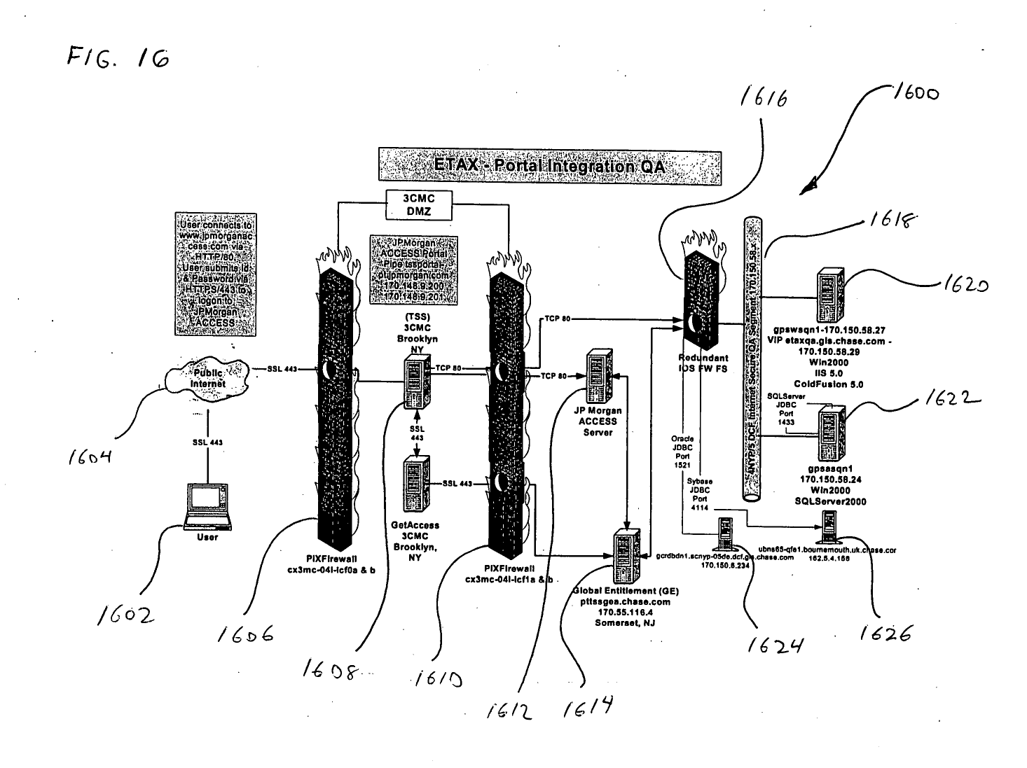

With reference to FIG. 1, there is shown an architecture 100 in accordance with an embodiment of the present invention. A financial client 101 communicates with a system 110 via a network 102. Network 102 can be any type of distributed network, such as, for example, a corporate intranet, or the Internet. System 110 can include one or more servers programmed and configured into logical portions in accordance with embodiments of the invention.

System 110 can include system server 112, for managing information flow within system 110 and to coordinate functionality among others portions of the system. System 110 can also include one or more servers for handling specific types of finance-related data and information. Such servers can include a products server 120, for maintaining and handling information related to financial products, and a tools server 130 for maintaining and handling information related to financial tools. Also included can be an external site server 140, for maintaining and handling information related to Web sites external to the system that contain related financial information.

A tax news server 150 can process, maintain, and sort tax news information and data related to financial products. Information and client-portfolio data related to a client 101 investor's financial portfolio can be managed and processed by a client data server 160.

The servers can also include an “effect of tax news-data on client data” server 170, for maintaining and handling information related to the effect that tax news data will have on client-portfolio data. In addition, the servers can also include a “hypothetical effect of tax news data on client data” server 180 for maintaining and handling information related to the effect that tax news data would have on hypothetical allocations of a client's portfolio.

While system 110 is described herein as including certain distinct servers for providing certain distinct functions, such description is made for ease of understanding. Accordingly, functions described herein as being performed by multiple servers could be performed by a single server, and likewise, functions described herein as being performed by a single server could be performed by multiple servers, as would be understood by one of skill in the art, as instructed by the present disclosure. In addition, while servers are described herein as performing the various functions of system 110, system 110 could be implemented by other combinations of hardware and software sub-systems as would be understood by one of skill in the art, as instructed by the present disclosure.

With reference to FIG. 2, there is shown, in further detail, certain logical categories of information provided and employed by embodiments of the present invention. Embodiments of the invention can include one or more of the following categories of information.

Products information 220 can include various financial and tax products to benefit and assist an investor. These products can include entity specific products. Tools information 230 includes financial tools to assist a client investor in preparing certain financial and tax calculations and estimates. Such tools can include, by way of non-limiting example, a tax profiles tool, a transaction taxes tool, an account opening tool, various training tools, and a reclaim processing calculator tool.

External sites information 240 includes information related to relevant financial Web sites outside of system 110, such as, for example, the Web site of the Internal Revenue Service (IRS). Tax news data information 250 can include various types of information with a potential impact on the financial portfolio of an investor. Such tax news data information 250 can include news flashes, monthly tax monitor reports, market reports, and a forms library.

Client data information 260 includes information related to the financial portfolio of a client 101. Such client data information 260 can include portfolio values, transaction values, permanent records, tax documents, processing data, and tax reporting data.

Effects of tax news data 250 on client data information 270 includes information related to the effects of tax news data 250 on the client's 101 portfolio. In addition, hypothetical effects of tax news data 250 on client data information 280 includes information related to the effects of tax news data 250 on the client's 101 portfolio.

With reference to FIG. 3, there is shown certain paths of information flow in accordance with embodiments of the invention. In general, effects of tax news data on client-data server 170 can access information from tax news server 150, as well as client data server 160, in order to determine the effects of tax news data 250 on client-data 260. Further, hypothetical effects of tax news data on client-data server 180 can also access information from news server 150, as well as client data server 160, in order to determine the hypothetical effects of tax news data 250 on client data 260.

Thus, by way of the claimed invention, client data 260 including information related to a client's 101 financial portfolio can be related to tax news data 250, including changes to financial and tax laws to determine the effects of those changes on the client's 101 financial portfolio. In addition, portions of the client's 101 financial portfolio can be hypothetically reallocated and the effects of the tax news data 250 on the hypothetical reallocations can be determined. Moreover, the effects of the tax news data 250 on the client data 260 can be determined on a country-by-country basis.

In use, a client 101 investor can make use of embodiments of the invention by accessing certain system Web pages, as described in greater detail below.

With reference to FIG. 4, a main user screen 400 in accordance with an embodiment of the invention is shown. A user can access various screen tabs, such as a products tab 410, news tab 500, client data 800, tools tab 600, and external sites tab 700. Main display window 402 provides various information blocks and links to facilitate navigation throughout the system 110. Main display window 402 includes information panel 408, which provides information regarding certain Web pages of the system 110.

With reference to FIGS. 5a and 5b, there is shown a listing of news flashes in accordance with an embodiment of the invention. After navigating to the news tab 500, the client 101 is provided with access to several news sub-tabs. The news flashes sub-tab 520 provides a display 502 including a news flashes display panel 522 that provides a listing of individual news flashes 524. Each news flash listing can include a title portion 525 and a date portion 526.

A search panel 504 facilitates a search of the new flash listings 524 by date period 506, region 508, country 510 and keyword search 512.

By selecting a specific news flash 524, a news flash display 527 is provided, as is shown in FIG. 5b. A news flash display 527 can include an explanation portion 529, as well as a category portion, providing category information related to the news flash explanation portion 529.

With reference to FIGS. 6a and 6b, there is shown a listing of monthly tax monitors in accordance with an embodiment of the invention. By selecting the monthly tax monitor sub-tab 330, the client 101 is provided with a tax monitor display portion 532, including individual listings of monthly tax monitors 533, each including a title portion 535. A search panel 504 facilitates a search of the new flash listings 524 by date period 506, region 508, country 510 and keyword search 512. The client 101 can also restrict the keyword search to a search of tax news segments of the tax news monitors.

Selecting a tax news monitor link provides a display of a tax news monitor display 537, including tax news monitor descriptive information 539, and a tax news monitor category panel 538, for providing category information.

With reference to FIGS. 7a-7c, there is shown a listing of market reports in accordance with an embodiment of the invention. Selection of the market reports sub-tab 540 provides a display of a market reports display panel 542, which includes listings of individual market reports 543. Each of the market report listings 543 can include a segment portion 545, and a title portion 546. A search of the listing of market reports 543 can be performed based upon region 506, country 510, market segment 511, and keyword search 512.

Selection of a market segment listing 543 provides display of an individual market report 547. The market report 547 includes a category panel 549 that lists category information for the market report 547. In the displayed example, statutory tax rates for France are displayed along with links directed to individual sub-topics 548 for dividends, corporate interest, government interest, and capital gains. A click on the sub-topic 548 for dividends provides, with particular reference to FIG. 7c, a display of sub-topic information 541, regarding dividends tax information in France, in this example.

With reference to FIGS. 8a-8c, there is shown a listing of forms in a forms library, in accordance with an embodiment of the invention. Selecting the forms library sub-tab provides a forms listing display 552 including individual forms listings 553. A search of the forms listings can be made via country of issue 506, or via a keyword search 512. If a forms listing 553 is selected, a forms download page 555 can be displayed. The forms download page can include a category display panel 556, displaying description and category information, and forms download icons 557 for viewing and/or downloading a particular form document. In turn, selecting a download icon 557 provides a display of the appropriate form 558.

With reference to FIGS. 9a and 9b, there is shown a listing of tax profiles in accordance with an embodiment of the invention. Upon selecting the tools tab 600, several sub-tabs are displayed. Selection of the tax profiles sub-tab 620 provides a display of various country tax profile display panels 621. Each country tax profile display panel 621 can include a capital gains tax listing 622, a corporate interest listing 623, and dividends listing 624, and a government interest listing 625. Each of the listings can include a payment type field 626, a standard rate percent field 627, a reduced to percent field 628, a tax relief percent field 629, and a tax credit percent field 671.

Searches of the country tax profile display panels 621 can be performed by way of a search panel 602, via investor country 604, region of investment 606, country of investment 608, entity type 610, after the search is initialized via a search button 612. With particular reference to FIG. 9b, alternatively, country tax profile display panels 621 can be displayed including a notes field 672, with additional notes regarding each of the capital gains tax listing 622, a corporate interest listing 623, dividends listing 624, and a government interest listing 625. Searches can be performed, by way of non-limiting example, by selecting various permutations of the country of residence 604, region of investment 606, country of investment 608, and entity type 610 parameters.

With reference to FIG. 10, there is shown a listing of transaction taxes, in accordance with an embodiment of the invention. When the transaction taxes sub-tab 630 is selected, a display of various country transaction tax profile display panels 631 is provided. Each of the country transaction tax profile display panels 631 can include an exchange-brokerage fee listing 632 and a tax transaction fee listing 633. Each country transaction tax profile display panel 631 can include a fee type field 634, a security type field 635, an imposed by field 636, an amount field 637, a charged to field 638, and a notes field 639. A search of the country transaction tax profile display panels 631 can performed at a search panel 680, and can be initiated via a search button 683, via country of investment 681, or transaction tax or fee type 682.

With reference to FIGS. 11a-11c, there is shown a listing of account-opening documents, in accordance with an embodiment of the invention. With selection of the account-opening sub-tab 640, an account-opening display panel 641 is displayed. The account-opening display panel 641 can include individual account-opening document listings 642. Each account-opening document listing can include a form id field 643, a form name field 644, a version field 645, and a view links field 646. By way of search panel 682, a search can be initiated via country of residence 684, country of investment 685, entity type 686, or service type 687, by selecting an appropriate search button 683, 688. Searches can be performed, by way of non-limiting example, by selecting various permutations of the country of residence 684, country of investment 685, and entity type 686 parameters.

If an account-opening document listing 642 is selected, an account-opening document page can be displayed. (FIG. 11b). The document download page can include a category display panel 648, displaying description and category information, and document download icons 647, for viewing and/or downloading a particular form document. In turn, selecting a download icon 647 provides a display of the appropriate document 649. (FIG. 11c).

With reference to FIGS. 12a and 12b, there is shown a listing of external Web sites, in accordance with an embodiment of the invention. Selection of the external sites tab provides a display of external Web site listings 710. Each external Web site listing can include a country field 712, a description field 714, and a publisher field 716. The external Web site listings 710 can be searched, by way of search panel 702, via country 704, publisher 706, or keyword 708.

With reference to FIGS. 13a-13h, there is shown a listing of client data information, in accordance with an embodiment of the invention. Selection of the client data tab 800 provides a display of several sub-tabs including a portfolio values sub-tab 820, a transaction values sub-tab 840, a permanent record sub-tab 860, a tax documents sub-tab 880, a processing data sub-tab 910, and a tax reporting data sub-tab 920.

With particular reference to FIG. 13b, selection of the permanent record sub-tab 860 provides a display of a permanent record screen 862. The permanent record screen 862 can include an investor identification panel 863, and a sub-account panel 864. The investor identification panel 863 can include information related to the investor such as, for example, a beneficial owner name and number, the relationship manager and name, the entity type, country of residence of the investor, the service level of the account and tax identification number. The sub-account panel 864 can include information related to sub-accounts of the investor

With particular reference to FIG. 13c, selection of portfolio values sub-tab 820 provides a display of a portfolio values screen 821. Portfolio values screen 821 can include an investor identification panel 822, and a sub-account panel 823. In addition, portfolio values screen 821 can include a securities holdings apportionment panel 824, which can include a graphical representation, such a pie chart, indicating the apportionment of various securities in a portfolio based on the country in which the investment is made.

With reference to FIG. 13d, a client documentation profile screen 881 can include an investor identification panel 882, a sub-account panel 883, and a tax document required panel 884, which provides information related to required tax documents. Referring to FIG. 13e, selecting a link in the tax document required panel 884 initiates the display of a pop-up window providing addition information related to the selected required tax document. Information displayed on client documentation profile screen 881 include, by way of non-limiting example, a listing of received and/or outstanding tax documents, and renewal dates, as well as other related listings of information.

As illustrated in FIG. 13f, a reclaim reporting screen 921 can also be displayed. Reclaim reporting screen 921 can include an investor identification panel 822, a sub-account panel 923, and links for viewing a summary 925, statement 9276 and detail 927 of tax reclaim reports. Selecting the tax claims reports statement 926 indicator initiates the display of outstanding tax reclaims statement 924 (FIG. 13g), which provides information related to tax reclaims for a portfolio with respect to the different countries in which the portfolio is invested.

In addition, certain embodiments of the invention include a tab for security level data attributes (not shown). Such security level attributes can include income types, and taxable attributes such as short-term, long-term capital gains distributions, the source country, as well as other related parameters, by way of non-limiting example.

Embodiments of the invention can include all of the Web pages and screens described herein, including all of the news and portfolio information described herein. Alternative embodiments of the invention, however, can include additional or fewer of the Web pages and screens described herein. In addition, alternative embodiments of the invention can include Web pages and screens having additional information, or less information, as a matter of design choice as would be performed by one of skill in the art, as instructed by the present disclosure.

A method 1400 of providing information related to a financial portfolio, in accordance with embodiments of the invention, is shown in FIG. 14. In step 1410, tax news data is received. Such tax news data can be related to changes in financial or tax laws and rules, and can be specific to a certain country. Next, in step 1420, the system determines which country is affected by the tax news data. Next, in step 1430, the tax news data is correlated with client data. The client data can be information related to a client's 101 financial portfolio. The client data can also include information related to which portions of a client's 101 financial portfolio are invested in what countries. Finally, in step 1440, the effects of the tax news data on the client data is determined. Such determining of the effects can include determining the effects that a change in the financial or tax laws in a particular country will have on the portion of a client 101 investor's portfolio that is invested in that country.

Another method 1500 of providing information related to a financial portfolio, in accordance with embodiments of the invention, is shown in FIG. 15. In step 1510, tax news data is received. Such news data can be related to changes in financial or tax laws and rules, and can be specific to a certain country. Next, in step 1520, the system determines what country is affected by the tax news data. Next, in step 1530, a query from a client 101 investor or other entity is received regarding correlating the tax news data with hypothetical client data, such as, for example, a hypothetical reallocation of a client 101 investor's portfolio into a different country. The client data can be information related to a client's 101 financial portfolio. Finally, in step 1540, the effects of the tax news data on the hypothetical client data is determined. Such determining of the effects can include determining the effects that a change in the financial or tax laws in a particular country will have on the portion of a client 101 investor's portfolio that is hypothetically invested in that country. By way of such a method, a client 101 investor can plan future investment strategies based on upcoming changes to financial and tax laws in various countries. Such changes can include, by way of non-limiting example, statutory and treaty changes.

In use, an embodiment of the invention could display to client 101 investor, on May 1, a tax news item, such as a news flash, stating, for example, that on June 1, Mexico will begin to tax interest paid on government debt. A client 101 that receives 5% interest on a MXP 2,000,000 investment prior to the change in the Mexican tax law could, could determine that its tax amount in Mexico would increase from a MXP 0 to MXP 4,900. Consequently, the system could determine and display that the rate of return on the client's 101 investment in Mexico would, all other things being equal, decrease from 5% to 4.755%. The client 101 investor can then perform additional hypothetical calculations to determine in which, if any, countries the MXP 2,000,000 investment would return greater than 4.755% interest after tax. The client 101 investor could then plan to reallocate its investment portfolio accordingly.

With reference to FIG. 16, there is shown an exemplary system architecture 1600, in accordance with an embodiment of the invention. A user at a user computer 1602 can connect via the Internet 1604, to an access portal server 1608, via a firewall 1606. The data path continues through another firewall 1610 to access servers 1612, 1614. A redundant firewall 1616 protects an Internet secure QA segment 1618, and two additional servers 1620, 1622, as well as servers 1624, 1626. In alternate embodiments, the architecture can be arranged in different configurations.

Accordingly, by way of embodiments of the invention, a client 101 investor having a portfolio invested in several countries can easily and efficiently learn of changes in tax and financial laws as well as news and current events having financial ramifications in a certain country, and link directly to a Web page having information about the specific types and values of investments of the portfolio in that certain country. The client 101 investor can also be advised about the effects that the changes to the tax and financial laws will or may have on the investments in that country, and run hypothetical scenarios regarding increasing and/or decreasing certain investments in that country and the ramifications that the changes to the tax and financial laws in that country would have on those hypothetical investment changes. The process can be repeated for each country in which the investor has investments, or for any countries in which the investor may wish to invest in the future.

In certain embodiments of the invention, client 101 can be a non-U.S. qualified intermediary client. Embodiments of the invention can provide such an intermediary client with information related to its accounts, and perform portions of the tax processing required, for example, under U.S. Internal Reveue Code Section 1441. In addition, certain embodiments of the invention can provide to the client 101 tax reports which are filed to various tax authorities, such as, for example, the U.S. Internal Revenue Service. Also, services such as electronic filing of tax documents can also be performed by way of certain embodiments of the invention.

It is to be understood that the exemplary embodiments are merely illustrative of the invention and that many variations of the above-described embodiments can be devised by one skilled in the art without departing from the scope of the invention. It is therefore intended that all such variations be included within the scope of the following claims and their equivalents.

1. A computer-implemented method for providing information related to a financial portfolio of a client, the financial portfolio's allocation among at least one country and information related to at least one effect of at least one change to at least one rule associated with the financial portfolio, the method comprising:
storing data and instructions in a non-transitory electronic database via one or more electronic communication interfaces to transmit the information related to the effects of at least one change to at least one rule on the financial portfolio, said data corresponding to:
one or more financial products associated with the financial portfolio;
allocation of the financial portfolio among the at least one country;
one or more categories of interest to the client; and
a set of rules associated with the financial portfolio;
accessing the non-transitory electronic database by a computer processor to execute instructions stored at said non-transitory electronic database, and to perform steps including:
receiving over a network, using a receiving engine, tax news data relating to at least one change to at least one rule from the set of rules associated with the financial portfolio, the receiving engine processing, maintaining and sorting the tax news data;
determining, using a processing engine at least one country corresponding to the tax news data and associating the tax news data with the at least one country;
determining, using the processing engine, at least one change to at least one rule from the set of rules associated with the financial portfolio, based on the tax news data;
retrieving from the electronic database, using a data retrieval engine via a network, data relating to the financial portfolio of the client, the allocation of the financial portfolio among at least one country, one or more categories of interest to the client and one or more metrics associated with the financial portfolio, the data retrieval engine processing and managing the received data;
computing, using a computation engine, the at least one effect of the at least one change to the at least one rule from the set of rules associated with the financial portfolio; and
identifying, using a tax profile determination engine, a tax profile associated with the financial portfolio of the client, wherein the tax profile comprises the at least one effect of the at least one change to the at least one rule from the set of rules associated with the financial portfolio, and further wherein the tax profile is categorized based on the one or more categories of interest to the client; and
displaying, on a user interface of a display device to the client, the tax profile including the at least one effect of the at least one change.

2. (canceled)

3. The computer-implemented method of claim 1, wherein the tax news data identifies a change in tax laws in the country.

4. The computer-implemented method of claim 1, wherein the tax news data identifies a tax treaty involving the country.

5. The computer-implemented method of claim 3, further comprising the steps of:
determining a date when the change in the tax laws is scheduled to take place; and
providing an alert to the client prior to the date;

6. The computer-implemented method of claim 4, further comprising the steps of:
determining a date when a negotiation or ratification of the tax treaty is scheduled to take place; and
providing an alert to the client prior to the date.

7-37. (canceled)

38. The computer-implemented method of claim 1, wherein the categories of interest to the client comprises of at least one of:
financial portfolio values;
transaction values;
permanent record;
tax documents;
processing data; and
tax reporting data.

39. The computer-implemented method of claim 1, further comprising determining a hypothetical effect of at least one change to the at least one rule from the set of rules associated with the financial portfolio of the client.

40. The computer computer-implemented method of claim 1, further comprising reallocating the financial portfolio of the client among at least one country based on the tax profile associated with the financial portfolio of the client.

41. The computer computer-implemented method of claim 1, further comprising searching for the one or more financial products associated with the financial portfolio of the client.

42. A computerized system for providing information related to a financial portfolio of a client, the financial portfolio's allocation among at least one country and information related to at least one effect of at least one change to at least one rule associated with the financial portfolio, the system comprising:
at least one non-transitory electronic database for storing data and instructions to transmit the information related to the effects of at least one change to at least one rule on the portfolio, said data corresponding to:
one or more financial products associated with the financial portfolio;
allocation of the financial portfolio among the at least one country;
one or more categories of interest to the client; and
a set of rules associated with the financial portfolio;
at least one computer processor accessing the data and instructions stored at said non-transitory electronic database, and executing instructions to operate as:
a receiving engine that processes, maintains and sorts tax news data received over a network;
a processing engine that determines at least one country corresponding to the tax news data and associates the tax news data with the at least one country, wherein the processing engine determines at least one change to at least one rule from the set of rules associated with the financial portfolio, based on the tax news data;
a data retrieval engine that retrieves from the electronic database, data relating to the financial portfolio of the client, the allocation of the financial portfolio among at least one country, one or more categories of interest to the client and one or more metrics associated with the financial portfolio, wherein the data retrieval engine processes and manages the received data;
a computation engine that computes the at least one effect of the at least one change to the at least one rule from the set of rules associated with the financial portfolio;
a tax profile determination engine-that identifies a tax profile associated with the financial portfolio of the client, wherein the tax profile comprises the at least one effect of the at least one change to the at least one rule from the set of rules associated with the financial portfolio, and further wherein the tax profile is categorized based on the one or more categories of interest to the client; and
a display device, displaying on a user interface, to the client, the tax profile including the at least one effect of the at least one change.

43. The computerized system of claim 42, wherein the tax news data identifies a change in tax laws in the country.

44. The computerized system of claim 42, wherein the tax news data identifies a tax treaty involving the country.

45. The computerized system of claim 43, further comprising an alert engine for:
determining a date when the change in the tax laws is scheduled to take place; and
providing an alert to the client prior to the date.

46. The computerized system of claim 44, further comprising an alert engine for:
determining a date when a negotiation or ratification of the tax treaty is scheduled to take place; and
providing an alert to the client prior to the date.

47. The computerized system of claim 42, wherein the categories of interest to the client comprises of at least one of:
financial portfolio values;
transaction values;
permanent record;
tax documents;
processing data; and
tax reporting data.

48. The computerized system of claim 42, further comprising a hypothesis generation engine for determining a hypothetical effect of at least one change to the at least one rule from the set of rules associated with the financial portfolio of the client.

49. The computerized system of claim 42, further comprising a reallocation engine for reallocating the financial portfolio of the client among at least one country based on the tax profile associated with the financial portfolio of the client.

50. The computerized system of claim 42, further comprising a search engine for searching for the one or more financial products associated with the financial portfolio of the client.
